(19) United States
(12) Patent Application Publication
(10) Pub. No.: US 2014/0090897 A1
(43) Pub. Date: Apr. 3, 2014

(54) INVERT WELLBORE FLUID

(71) Applicants: Lijein Lee, Sugar Land, TX (US); Steven Young, Cypress, TX (US); John Chapman, Greely, CO (US)

(72) Inventors: Lijein Lee, Sugar Land, TX (US); Steven Young, Cypress, TX (US); John Chapman, Greely, CO (US)

(73) Assignee: M-I L.L.C., Houston, TX (US)

(21) Appl. No.: 14/097,299

(22) Filed: Dec. 5, 2013

Related U.S. Application Data
(63) Continuation-in-part of application No. 14/006,149.

(30) Foreign Application Priority Data
Mar. 21, 2011 (GB) 1104691.9

(51) Int. Cl. C09K 8/28

(52) U.S. Cl. CPC C09K 8/28
USPC 175/65; 507/118

(57) ABSTRACT

There is described an invert emulsion wellbore fluid that includes: an oleaginous external phase; a non-oleaginous internal phase; an emulsifier; and a rheological additive comprising a sulphonated polymer formed from 100 to 10,000 monomers. There is also described a method of drilling a subterranean hole using the invert emulsion drilling fluid.

### CROSS-REFERENCE TO RELATED APPLICATIONS

This application is a continuation-in-part application of U.S. patent application Ser. No. 14/006,149, filed on Sep. 19, 2013, which is a national stage application of PCT/GB2012/050619, filed on Mar. 21, 2012, which claims priority to GB 1104691.9 filed on Mar. 21, 2011, all of which are incorporated by reference in their entirety.

### BACKGROUND

During the drilling of a wellbore, various fluids are typically used in the well for a variety of functions. The fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

In certain rotary drilling procedures the drilling fluid takes the form of a “mud,” i.e., a liquid having solids suspended therein. The solids function to impart desired rheological properties to the drilling fluid and also to increase the density thereof in order to provide a suitable hydrostatic pressure at the bottom of the well. The drilling mud may be either a water-based or an oil-based mud. Alternatively the drilling fluid may be a completion fluid (especially a solids free completion fluid) or a so-called pill.

Many types of fluids have been used in wellbores particularly in connection with the drilling of oil and gas wells. The selection of an oil-based wellbore fluid involves a careful balance of the required fluid characteristics and the environmental impact of such fluids in a particular application. The primary benefits of selecting an oil-based drilling fluid include: superior hole stability, especially in shale formations; formation of a thinner filter cake than the filter cake achieved with a water based mud; excellent lubrication of the drilling string and downhole tools; penetration of salt beds without sloughing or enlargement of the hole as well. An especially beneficial property of oil-based muds is their lubrication qualities. These lubrication properties permit the drilling of wells having a significant vertical deviation, as is typical of off-shore or deep water drilling operations or when a horizontal well is desired. In such highly deviated holes, torque and drag on the drill string are a significant problem because the drill pipe lies against the low side of the hole, and the risk of pipe sticking is high when water based muds are used. In contrast oil based muds provide a thin, slick filter cake which helps to prevent pipe sticking and thus the use of the oil-based mud can be justified.

Oil-based drilling fluids are generally used in the form of invert emulsion muds. The components of the invert emulsion fluids include an oleaginous liquid such as hydrocarbon oil which serves as a continuous phase, a non-oleaginous liquid such as water or brine solution which serves as a discontinuous phase, and an emulsifying agent. The oil/water (or oil:water) ratio of invert emulsion fluids is traditionally within the range of 65:45 to 95:5. The emulsifying agent serves to lower the interfacial tension of the liquids so that the non-oleaginous liquid may form a stable dispersion of fine droplets in the oleaginous liquid. A full description of such invert emulsions may be found in Composition and Properties of Drilling and Completion Fluids, 5^{th} Edition, H. C. H. Darley, George R. Gray, Gulf Publishing Company, 1988, pp. 328-332.

Additionally, such invert emulsion muds generally contain one or more weighting agents, surfactants, viscosifiers, fluid loss control agents or bridging agents. The drawback to use of invert emulsion fluids is their cost (due to the oil content) and environmental concerns associated with waste and disposal (greater oil percentage may be correlated to more oil retention on drilled cuttings). However, as the oil to water ratio decreases (increased internal water phase), the viscosity of the fluid often increases beyond a workable range. Additionally, it also becomes more difficult to stabilize an invert emulsion (water-in-oil) as the water content increases.

### SUMMARY

In one aspect, embodiments disclosed herein relate to

This summary is provided to introduce a selection of concepts that are further described below in the detailed description. This summary is not intended to identify key or essential features of the claimed subject matter, nor is it intended to be used as an aid in limiting the scope of the claimed subject matter. Other aspects and advantages will be apparent from the following description and the appended claims.

### BRIEF DESCRIPTION OF DRAWINGS

FIG. 1 is a concentration profile showing the main theology parameters for ETHOCEL 300;

FIG. 2 is a concentration profile showing the main rheology parameters for a chlorosulphonated polymer;

FIG. 3 is a table showing the results of ageing fluids comprising rheological additives according to the present disclosure;

FIG. 4 shows the amount of rheological additive required to gain a viscosity at low shear rate for a known rheological additive and rheological additives according to the presently disclosure;

FIG. 5 shows the plastic viscosity gained for the fluid based on the amount of rheological modifier required to reach the low shear viscosity set out in FIG. 4.

FIGS. 6A-D show the FANN 70 rheological profile of a invert emulsion field sample.

FIG. 7 shows the rheological profile of an invert emulsion field sample with and without additional comparative viscosifiers.

FIG. 8 shows the sag profile of an invert emulsion field sample with and without additional comparative viscosifiers.

FIG. 9 shows the rheological profile of an invert emulsion field sample with and without additional viscosifiers.

FIG. 10 shows the sag profile of an invert emulsion field sample with and without additional viscosifiers.

### DETAILED DESCRIPTION

In one aspect, the disclosure provides an invert emulsion wellbore fluid that includes:
an oleaginous external phase;
a non-oleaginous internal phase, wherein a ratio of the oleaginous external phase and non-oleaginous internal phase is optionally less than 50:50, but may be greater than 50:50 in other embodiments;
an emulsifier;
a rheological additive comprising a sulphonated polymer formed from 100 to 10,000 monomers.

The terms ‘monomer’ and ‘repeat unit’ are used interchangeably herein and have the same meaning. The polymer may be produced from at least one monomer by a polymerisation reaction. Such polymerisation reactions are known in the art. Thus, the sulphonated polymer described herein is obtainable by the polymerisation of from 100 to 10,000 monomers.

The polymer may be formed from 500 to 10,000 monomers (repeat units), and typically in the range of from 1,000 to 10,000 monomers (repeat units).

The sulphonated polymer may be formed from at least one monomer that is sulphonated.

The sulphonated polymer may be a copolymer formed from at least one polymer which is sulphonated and at least one monomer that is not sulphonated.

The sulphonated polymer may be formed from a base polymer and subsequently sulphonated. The sulphonation may be achieved by processes known in the art. The base polymer may be formed from ethylene propylene diene monomer (EPDM) units.

The sulphonated polymer comprises a sulphonate functional group, such as —SO₃X where X is hydrogen or a cation, particularly a monovalent cation such as one or more of the group comprising Li⁺, Na⁺ and K⁺. The sulphonate functional group may also be a chlorosulphonate group.

The rheological additive is used to control the rheological profile of the wellbore fluid. Although the emulsifier may affect the rheology of the wellbore fluid, it is the additive is used to control the rheology. The rheological additive may specifically be used to control the low shear rate viscosity of the wellbore fluid.

The rheological additive may be in one or both of the oleaginous and non-oleaginous phase. Typically the rheological additive is present at an interface between the oleaginous or non-oleaginous phase.

Unlike a surfactant, the rheological additive affects the low shear rate viscosity of the wellbore fluid. The rheological additive may have (i) an oil soluble backbone (for instance the polymer backbone), (ii) functionality (an ionic component) responsible for the interaction between and/or within portions of the rheological additive (for instance the sulphonate group) and (iii) bulk (molecular weight) provided by the length of the chain of the backbone. The balance of (i), (ii) and (iii) may provide the necessary control of the rheological profile of the wellbore fluid. Surfactants do not have the right balance of these components.

The term oleaginous is used herein to refer to all oil and oil dispersible and soluble additives. The term non-oleaginous is used herein to refer to all water and water dispersible and soluble additives.

All ratios detailed herein relate to volume ratio. When calculating oleaginous/non-oleaginous rations such as oil water ratios, the oleaginous phase, typically the oil phase includes all oil-based components of the emulsion whilst the non-oleaginous phase, typically the water phase includes only water.

For certain embodiments, the sulphonated polymer is an elastomeric based polymer. Preferably the polymer has a number average molecular weight of more than 20,000. Elastomeric based polymers typically have a molecular weight of from 20,000 to 500,000.

A fluid as described herein with a ratio of the oleaginous external phase and non oleaginous internal-phase being less than 50:50 by volume (that is less than 50 parts by volume of the oleaginous external phase to 50 parts by volume of the non-oleaginous internal phase) is referred to as a High Internal Phase Ratio (HIPR) fluid or alternatively may also be referred to as high internal phase emulsions (HIPE).

The inventors of the present disclosure have found that whilst improved properties are apparent from the use of HIPR fluids that the viscosity at low shear rate, normally tested at 6 rpm on a FANN 35 viscometer, is too low when compared to the viscosity at high shear rate (the difference between the 600 rpm and 300 rpm reading on a FANN 35 viscometer and referred to as the plastic viscosity). This can lead to poor hole cleaning and/or sag of a weighting agent added to the fluid in use. Thus the inventors have recognised that a rheological additive which can modify or control the viscosity at the low shear rate while having low impact on the high shear rate viscosity would be beneficial.

The inventors of the present disclosure have appreciated that the inclusion of a rheological modifier comprising a sulphonated polymer can increase the viscosity at the low shear rate and/or reduce the viscosity at the high shear rate/plastic viscosity.

However, embodiments of the present disclosure also relate to fluids having a ratio of the oleaginous external phase and non-oleaginous internal phase as being greater than 50:50 that is greater than 50 parts by volume of the oleaginous external phase to 50 parts by volume of the non-oleaginous internal phase). Advantageously, the inventors of the present application have found that the presently claimed rheological additives may reduce sag even for conventional invert emulsion fluids having good theology, and also provide high temperature stability.

Thus, the concentration of the oleaginous fluid should be sufficient so that an invert emulsion forms and may be less than about 99% by volume of the invert emulsion. In one embodiment the amount of oleaginous fluid is from about 30% to about 95% by volume and from about 50% to about 90% by volume of the invert emulsion fluid. The oleaginous fluid in one embodiment may include at least 5% by volume of a material selected from the group including esters, ethers, acetals, dialkylcarbonates, hydrocarbons, and combinations thereof.

The sulphonated polymer may be a chlorosulphonated polymer. The sulphonated polymer may be prepared such that it is a chlorosulphonated polymer.

The sulphonated polymer may be an α-olefin copolymer. The α-olefin may provide the necessary reactivity for the production of the sulphonated polymer from its constituent monomer parts.

The chlorosulphonated polymer may be formed from a base polymer and subsequently sulphonated or may be formed from one or more monomers, at least one of which is chlorosulphonated. It may be formed from monomer units of ethylene and α-olefin, that is —(CH₂—CH₂)ₙ— and —(R⁵CH—CH₂)ₘ— wherein R⁵ is hydrogen or an alkyl radical having from 1 to 18 carbon atoms. The resulting base polymer may be subsequently chlorosulphonated. Alternatively, at least a portion of one or both of the ethylene and α-olefin may be substituted with a chlorosulphonate group.

Preferably the sulphonated polymer is formed from monomers which are derived from and typically may be, ethylene and an α-olefin that contains from 3 to 20 carbon atoms, optionally 4 to 8 carbon atoms.

Certain embodiments include a chlorosulphonated α-olefin copolymer which is formed from monomers which are derived from, and typically may be ethylene and an α-olefin that contains from 3 to 20 carbon atoms, optionally 4 to 8 carbon atoms.

The sulphonated polymer typically contains from 0.2 wt % to 5 wt % sulphur and can be reacted with water to yield a sulphonic acid or reacted and neutralised with a base to yield an alkali sulphonated copolymer.

In another aspect, the disclosure provides an invert emulsion wellbore fluid that includes:

an oleaginous external phase;

a non-oleaginous internal phase, wherein a ratio of the oleaginous external phase and non-oleaginous internal phase is optionally less than 50:50, but may be greater than 50:50 in other embodiments;

an emulsifier; and

a rheological additive comprising an organosoluble cellulose represented by the following formula:

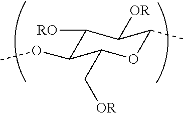

Wherein R is independently H or an alkyl radical having a carbon backbone of from 1 to 10 carbon atoms.

The organosoluble cellulose may be obtained from Dow Chemical Company (www.dow.com) as part of their Ethocel range. Ethocel 4 and Ethocel 20 having viscosity ranges of 3-5.5 and 18-22 cP respectively are preferred.

The organosoluble cellulose may be soluble in at least one organic solvent. The organosoluble cellulose may have a viscosity of from 0.1 to 120 cP at 25° C. in the organic solvent.

The organosoluble cellulose may have a viscosity of 0.1 to 250 cP. The viscosity of the organosoluble cellulose may be from 1 to 120, optionally 3-22 cP. The viscosity is measured under the conditions noted in the Ethocel product range (www.Dow.com that is in 5% solutions measured at 25° C. in an Ubbleohde type viscometer. For medium organosoluble cellulose products, the solvent is 60% toluene and 40% ethanol. For all other organosoluble cellulose products the solvent is 80% toluene and 20% ethanol.

Preferably the organosoluble cellulose has repeating anhydroglucose units. The anhydroglucose unit may be in the form of a ring. Each anhydroglucose ring may have three —OH (hydroxyl) sites, which are optionally alkoxylated to from —OR groups wherein R is an alkyl group with between 1 and 10, normally between 1 and 5 carbon atoms in a chain. In certain embodiments the —OH sites are ethoxylated to form —OC₂H₅ groups.

The wellbore fluid may be a variety of wellbore fluids including completion fluids with or without any solids, pills, and fluids containing heavy weight brine.

In various embodiments, particularly those involving HIPR fluids, the non-oleaginous internal phase may comprise a plurality of droplets. The droplets can be dispersed in the oleaginous external phase. Optionally an average diameter of the droplets comprising the non-oleaginous internal phase ranges from 0.5 to 5 micrometers, typically from 1 to 3 micrometers.

Optionally the invert emulsion wellbore fluid has a viscometer reading of less than 200 measured at 600 rpm, typically a viscometer reading of less than 40 at 6 and 3 rpm.

The polymer may be a derivative of cellulose. The cellulose may be a polysaccharide of glucose (monomer) units. Derivatisation of the cellulose may involve conversion of hydroxyl groups on the repeating glucose units to ethyl ether groups.

The polymer may be a depolymerised derivative of cellulose or alkyl derivatives thereof.

In yet another aspect, embodiments disclosed herein relate to a method of drilling a subterranean hole with an invert emulsion drilling fluid that may include mixing an oleaginous fluid, a non-oleaginous fluid, and a rheological additive to form an invert emulsion wellbore fluid and drilling the subterranean hole using said invert emulsion wellbore fluid as the drilling fluid. The invert emulsion may include an oleaginous external phase: a non oleaginous internal phase, wherein a ratio of the oleaginous external phase and non oleaginous internal phase is optionally less than 50:50, but may be greater than 50:50 in other embodiments; and a rheological additive stabilising the oleaginous external phase and the non-oleaginous internal phase, wherein the rheological additive is at least one of a sulphonated polymer and an organosoluble cellulose.

According to another aspect of the disclosure there may be provided an invert emulsion wellbore fluid that includes:
an emulsifier;
an oleaginous external phase;
a non-oleaginous internal phase, wherein a ratio of the oleaginous external phase and non-oleaginous internal phase is optionally less than 50:50, but may be greater than 50:50 in other embodiments; and wherein the non-oleaginous phase comprises a brine having a specific gravity of above 1.4.

The specific gravity of the brine may be above 1.55.

Normally such an aspect is provided for emulsions according to earlier aspects of the disclosure. The non-oleaginous internal phase of this aspect may be used in the other aspects of the disclosure described above.

In particular the fluid may further comprise a rheological additive comprising one of a sulphonated polymer and an organosolubale cellulose.

Optionally the fluid may possess a high shear viscosity of less than 200 at 600 rpm, and a low shear viscosity of less than 40 at 6 and 3 rpm, and less than 20 at 6 and 3 rpm in particular embodiments (all of which are measured using a Fann 35 Viscometer from Fann Instrument Company (Houston, Tex.) at 120° F. (48.9° C.)).

In another aspect, the disclosure provides an invert emulsion wellbore fluid that includes:
An oleaginous external phase;
a non-oleaginous internal phase, wherein a ration of the oleaginous external phase and no-elaginous internal phase is optionally less than 50:50, but may be greater than 50:50 in other embodiments;
an emulsifier;
a first rhealogical additive comprising a sulphonated polymer formed from 100 to 10,000 monomers; and
a second rhealogical additive comprising an organosoluble cellulose represented by the following formula:

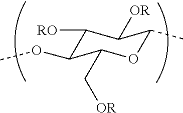

Wherein R is independently H or an alkyl radical having a carbon backbone of from 1 to 10 carbon atoms.

The invert emulsion wellbore fluid of this aspect may be used in the other aspects of the disclosure described above.

Other aspects and advantages of the disclosure will be apparent from the following description and the appended claims.

The oil/water ratio in invert emulsion fluids conventionally used in the field is in the range of 65/45 to 95/5, and in various embodiments of the present disclosure may range from 50/50 to 95/5. Several factors have conventionally dictated such ranges, including: the concentration of solids in the mud to provide the desired mud weight (solids laden muds must have a high oil/water (O/W) ratio to keep the solids oil wet and dispersed) and the high viscosities often experienced upon increase of the internal aqueous phase (due to the greater concentration of the dispersed internal phase). The instability of the emulsions may be explained by examining the principles of colloid chemistry. The stability of a colloidal dispersion (emulsion for a liquid:liquid dispersion) is determined by the behaviour of the surface of the particle via its surface charge and short-range attractive van der Waals forces. Electrostatic repulsion prevents dispersed particles from combining into their most thermodynamically stable state of aggregation, in macroscopic form, thus rendering the dispersions metastable. Emulsions are metastable systems for which phase separation of the oil and water phases represents the most stable thermodynamic state due to the addition of a surfactant to reduce the interfacial energy between oil and water.

Oil-in-water emulsions are typically stabilised by both electrostatic stabilisation (electric double layer between the two phases) and steric stabilisation (van der Waals repulsive forces), whereas invert emulsions (water-in-oil) are typically stabilised by only steric stabilisation. Because only one mechanism can be used to stabilise an invert emulsion, invert emulsions are generally more difficult to stabilise, particularly at higher levels of the internal phase, and are often highly viscous fluids.

Thus, embodiments of the present disclosure relate to invert emulsion fluids optionally having a high internal phase concentration (<50:50 oleaginous/non-oleaginous, typically O/W), which are stabilised by an emulsifying agent preferably without significant increases in viscosity. Additional by virtue of the greater internal phase concentration, weight may be provided to the fluid partly through the inherent weight of the aqueous or other internal phase, thus minimizing the total solid content. However, other embodiments are directed to fluids having a greater than 50/50 O/W ratio, including ratios up to 95/5.

The non-oleaginous phase is typically a brine. It may be a relatively dense brine. The specific gravity of the non-oleaginous phase may be above 1.4, optionally above 1.55. In some embodiments, the invert emulsion fluid may contain no solid component, including barite. However, in other embodiments, solid components, including barite or other weighting agents may be included, particularly in embodiments having a greater than 50/50 O/W ratio.

Weighting agents or density materials suitable for use in this disclosure include galena, hematite, magnetite, iron oxides, illmenite, barite, siderite, celestite, dolomite, calcite, and the like. The quantity of such material added, if any, depends upon the desired density of the final composition. Generally, weight material may be added to result in a drilling fluid density of up to about 24 pounds per gallon. The weight material may be added up to 21 pounds per gallon and up to 19.5 pounds per gallon in particular embodiments.

Thus embodiments of the present disclosure may independently provide an invert emulsion wellbore fluid that includes:
an emulsifier;
an oleaginous external phase;
a non-oleaginous internal phase,
   wherein a ratio of the oleaginous external phase and non-oleaginous internal phase is less than 50:50;
   and wherein the non-oleaginous phase comprises a brine having a specific gravity of above 1.4, optionally above 1.55.

Normally such an aspect is provided for emulsions according to earlier aspects of the present disclosure.

As discussed above, as the internal aqueous phase of a given fluid system increases, the viscosity and rheological profile of the fluid also increases due to the greater concentration of the dispersed internal phase. However, the invert emulsion fluids of the present disclosure may possess rheological profiles more similar to fluids having a lower internal phase concentration, i.e., >50:50 oleaginous/non-oleaginous, typically O/W. In particular, in accordance with embodiments of the present disclosure, the fluids may possess a high shear viscosity of less than 200 at 600 rpm, and a low shear viscosity of less than 40 at 6 and 3 rpm, and less than 20 at 6 and 3 rpm in particular embodiments (all of which are measured using a Fann 35 Viscometer from Fann Instrument Company (Houston, Tex.) at 120° F. (48.9° C.)). Further, for embodiments directed to conventional O/W ratios, the fluids containing the rheological modifiers of the present disclosure may possess less dynamic sag as compared to fluids formulated without such theological modifiers.

The fluid may also possess an internal non-oleaginous phase, typically aqueous phase, that is stably emulsed within the external oleaginous phase. Specifically, upon application of an electric field to an invert emulsion fluid, the emulsified non-oleaginous phase, which possesses charge, will migrate to one of the electrodes used to generate the electric field. The incorporation of emulsifiers in the invert emulsion fluid stabilises the emulsion and results in a slowing of the migration rate and/or increased voltage for breakage of the emulsion. Thus, an electrical stability (ES) test, specified by the American Petroleum Institute at API Recommended Practice 13B-2, Third Edition (February 1998), is often used to determine the stability of the emulsion. ES is determined by applying a voltage-ramped, sinusoidal electrical signal across a probe (consisting of a pair of parallel flat-plate electrodes) immersed in the mud. The resulting current remains low until a threshold voltage is reached, whereupon the current rises very rapidly. This threshold voltage is referred to as the ES (“the API ES”) of the mud and is defined as the voltage in peak volts-measured when the current reaches 61 μA. The test is performed by inserting the ES probe into a cup of 120° F. (48.9° C.) mud applying an increasing voltage (from 0 to 2000 volts) across an electrode gap in the probe. The higher the ES voltage measured for the fluid, the stronger or harder to break would be the emulsion created with the fluid, and the more stable the emulsion is. Thus, some embodiments of the present disclosure relate to invert emulsion fluids having a high internal phase ratio but that also have an electrical stability of at least 50 v and at least 100 v or 150 v in more particular embodiments.

Further, embodiments of the present disclosure also relate to fluids having a high internal phase ratio wherein the emulsion droplet size is smaller as compared to conventional emulsion droplets. For example, the non-oleaginous phase distributed in the oleaginous phase may comprise droplets having an average diameter in the range of 0.5 to 5 microns in one embodiment, and in the range of 1 to 3 microns in a more particular embodiment. The droplet size distribution may generally be such that at least 90% of the diameters are within 20% or especially 10% of the average diameter. In other embodiments, there may be a multimodal distribution. This droplet size may be approximately one quarter less than the size of droplets in conventional emulsions droplets formed using conventional emulsifiers. In a particular embodiment, the emulsion droplets may be smaller than the solid weighting agents used in the fluids.

The emulsifier may be any suitable emulsifier. In preferred embodiments, the emulsifier is an alkoxylated ether acid emulsifier which stabilises the oleaginous external phase and the non-oleaginous internal phase, wherein the alkoxylated ether acid is represented by the following formula:

R⁴O[CH₂CHR¹O]ₙ[CH₂]ₘ—COOH

where R⁴ is a C₆-C₂₄ alkyl or alkenyl radical or —C(O)R³ (where R³ is a C₁₀-C₂₂ alkyl or alkenyl radical);
R¹ is H or a C₁-C₄ alkyl radical;
n has a value of from 1 to 20; and
m has a value of from 0 to 4.

The C₆-C₂₄ alkyl or alkenyl radical of group R may be branched or unbranched (straight-chain).

Such compounds may be formed by the reaction of an alcohol with a polyether (such as poly(ethylene oxide), poly(propylene oxide), poly(butylene oxide), or copolymers of ethylene oxide, propylene oxide, and/or butylene oxide) to form an alkoxylated alcohol. The alkoxylated alcohol may then be reacted with an α-halocarboxylic acid (such as chloroacetic acid, chloropropionic acid, etc.) to form the alkoxylated ether acid. In a particular embodiment, the selection of n may be based on the lipophilicity of the compound and the type of polyether used in the alkoxylation. In some particular embodiments, where R¹ is H (formed from reaction with poly(ethylene oxide)), n may be 2 to 10 (between 2 and 5 in some embodiments and between 2 and 4 in more particular embodiments). In other particular embodiments, where R¹ is —CH₃, n may range up to 20 (and up to 15 in other embodiments). Further, selection of R (or R³) and R² may also be based on the hydrophilicity of the compound due to the extent of polyetherification (i.e., number of n). In selecting each R (or R³), R¹, R², and n, the relative hydrophilicity and lipophilicity contributed by each selection may be considered so that the desired hydrophilic-lipophilic balance (HLB) value may be achieved. Further, while this emulsifier may be particularly suitable for use in creating a fluid having a greater than 50% non-oleaginous internal phase, embodiments of the present disclosure may also include invert emulsion fluids formed with such emulsifier at lower internal phase amounts.

Emulsifiers are typically amphiphilic. That is, they possess both a hydrophilic portion and a hydrophobic portion. The chemistry and strength of the hydrophilic polar group compared with those of the lipophilic nonpolar group determine whether the emulsion forms as an oil-in-water or water-in-oil emulsion. In particular, emulsifiers may be evaluated based on their HLB value. Generally, to form a water in-oil emulsion, an emulsifier (or a mixture of emulsifiers) having a low HLB, such as between 3 and 8, may be desirable. In a particular embodiment, the HLB value of the emulsifier may range from 4 to 6.

In particular embodiments, the emulsifier may be used in an amount ranging from 1 to 15 pounds per barrel (lbm/bbl or ppb), that is from 2.85 to 42.80 kg/m³, and from 2 to 10 pounds per barrel (lbm/bbl or ppb), that is from 5.70 to 28.50 kg/m³ in other particular embodiments.

In addition to the emulsifying agent that stabilises the oleaginous continuous phase and non-oleaginous discontinuous phase, the wellbore fluids may also include, for example, weighting agents.

Weighting agents or density materials (other than the inherent weight provided by the Internal aqueous phase) suitable for use in the fluids disclosed herein may include barite, galena, hematite, magnetite, iron oxides, illmenite, siderite, celestite, dolomite, calcite, and the like. The quantity of such material added, if any, depends upon the desired density of the final composition. Typically, weighting material may be added to provide a fluid density of up to about 24 pounds per gallon (lbm/gal or ppg), that is a specific gravity of 2.87 (but up to 21 pounds per gallon (lbm/gal or ppg), that is a specific gravity of 2.50 or up to 19 pounds per gallon (lbm/gal or ppg), that is a specific gravity of 2.27 in other particular embodiments). Additionally, it is also within the scope of the present disclosure that the fluid may also be weighted using salts (such as in the non-oleaginous fluid (often aqueous fluid) discussed below). The selection of a particular material may depend largely on the density of the material as typically, the lowest wellbore fluid viscosity at any particular density is obtained by using the highest density particles.

The oleaginous fluid may be a liquid and more preferably is a natural or synthetic oil and more preferably the oleaginous fluid is selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds; and mixtures thereof. In a particular embodiment, the fluids may be formulated using diesel oil or a synthetic oil as the external phase. The concentration of the oleaginous fluid should be sufficient so that an invert emulsion forms and may be less than about 50% by volume of the invert emulsion. In one embodiment the amount of oleaginous fluid is from about 50% to about 20% by volume and more specifically about 40% to about 20% by volume of the invert emulsion fluid. However, other embodiments using a conventional O/W ratio may include an oleaginous fluid in an amount greater than 50% by volume of the invert emulsion, and ranging from 50% to 95% in one embodiment, and ranging from 60 to 90% in other embodiments. The oleaginous fluid in one embodiment may include at least 5% by volume of a material selected from the group including esters, ethers, acetals, dialkylcarbonates, hydrocarbons and combinations thereof.

The non-oleaginous fluid used in the formulation of the invert emulsion fluid disclosed herein is a liquid and preferably is an aqueous liquid. More preferably, the non-oleaginous liquid may be selected from the group including sea water, a brine containing organic and/or inorganic dissolved salts, liquids containing water miscible organic compounds and combinations thereof. For example, the aqueous fluid may be formulated with mixtures of desired salts in fresh water. Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminium, magnesium, potassium, strontium, and lithium, salts of chlorides, bromides, carbonates, iodides, chlorates, bromates, formates, nitrates, oxides, phosphates, sulphates, silicates, and fluorides. Salts that may be incorporated in a given brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

In one embodiment the amount of non-oleaginous fluid is more than about 50% by volume and preferably from about 50% to about 80% by volume of the invert emulsion fluid. In another embodiment, the non-oleaginous fluid is preferably from about 60% to about 80% by volume of the invert emulsion fluid. In embodiments using a convention O/W ratio, the amount of non-oleaginous fluid is less than about 50% volume, and may be 5 to 50% by volume or 10 to 40% by volume in various particular embodiments.

Conventional methods can be used to prepare the drilling fluids disclosed herein in a manner analogous to those normally used, to prepare conventional oil based drilling fluids. In one embodiment, a desired quantity of oleaginous fluid such as a base oil and a suitable amount of a surfactant are mixed together and the remaining components are added sequentially with continuous mixing. An invert emulsion may also be formed by vigorously agitating, mixing or shearing the oleaginous fluid and the non-oleaginous fluid.

Other additives that may be included in the wellbore fluids disclosed herein include for example, wetting agents, organophilic clays, viscosifiers, surfactants, dispersants, interfacial tension reducers, pH buffers, mutual solvents, thinners, thinning agents and cleaning agents.

Wetting agents that may be suitable for use in the fluids disclosed herein include crude tall oil, oxidized crude tall oil, surfactants, organic phosphate esters, modified imidazolines and amidoamines, alkyl aromatic sulphates and sulphonates, and the like, and combinations or derivatives of these. However, when used with the invert emulsion fluid, the use of fatty acid wetting agents should be minimised so as to not adversely affect the reversibility of the invert emulsion disclosed herein. FAZEWET™, VERSA COAT™, SUREWET™, VERSA WET™, and VERSAWET™ NS are examples of commercially available wetting agents manufactured and distributed by M-I L.L.C., that may be used in the fluids disclosed herein. SILWET™ L-77, L-7001, L7605, and L-7622 are examples of commercially available surfactants and wetting agents manufactured and distributed by General Electric Company (Wilton, Conn.).

Organophilic clays, normally amine treated clays, may be added in addition to the viscosifiers described herein. Other viscosifiers, such as oil soluble polymers, polyamide resins, polycarboxylic acids and soaps can also be used. The amount of viscosifier used in the composition can vary upon the end use of the composition. However, normally about 0.1% to about 6% by weight range is sufficient for most applications. VG-69™ and VG-PLUS™ are organoclay materials distributed by M-I, L.L.C., and VERSA-HRP™ is a polyamide resin material manufactured and distributed by M-I, L.L.C., that may be used in the fluids disclosed herein. In some embodiments, the viscosity of the displacement fluids is sufficiently high such that the displacement fluid may act as its own displacement pill in a well.

Conventional suspending agents, as well as those described herein, may be used in the fluids disclosed herein and include organophilic clays, amine treated clays, oil soluble polymers, polyamide resins, polycarboxylic acids, and soaps. The amount of conventional suspending agent used in the composition, if any, may vary depending upon the end use of the composition. However, normally about 0.1% to about 6% by weight is sufficient for most applications. VG-69™ and VG-PLUS™ are organoclay materials distributed by M-I L.L.C., and VERSA-HRP™ is a polyamide resin material manufactured and distributed by M-I L.L.C., that may be used in the fluids disclosed herein.

Additionally, lime or other alkaline materials are typically added to conventional invert emulsion drilling fluids and muds to maintain a reserve alkalinity. The fluids disclosed herein are especially useful in the drilling, completion and working over of subterranean oil and gas wells. In particular the fluids disclosed herein may find use in formulating drilling muds and completion fluids that allow for the easy and quick removal of the filter cake. Such muds and fluids are especially useful in the drilling of horizontal wells into hydrocarbon bearing formations. In various embodiments, methods of drilling a subterranean hole with an invert emulsion drilling fluid may comprise mixing an oleaginous fluid, a non-oleaginous fluid, a viscosifier, such as those described above, and in the ratios described above, to form an invert emulsion; and drilling the subterranean hole using this invert emulsion as the drilling fluid. The fluid may be pumped down to the bottom of the well through a drill pipe, where the fluid emerges through ports in the drilling bit, for example. In one embodiment, the fluid may be used in conjunction with any drilling operation, which may include, for example, vertical drilling, extended reach drilling, and directional drilling. Oil-based drilling muds may be prepared with a large variety of formulations. Specific formulations may depend on the state of drilling a well at a particular time, for example, depending on the depth and/or the composition of the formation.

### EXAMPLES

### Example 1

A series of experiments were carried out using a mud formulation made up on a Hamilton Beech mixer over an hour with the following order of addition:

1. Mosspar H oil (continuous phase)
2. Emulsifier, oil wetting agent, for example EMI-2184 (available from M-I L.L.C.)/Surewet
3. Conventional Organophilic rheology modifier (viscosifier gellant): VG Supreme
4. Ecotrol RD (fluid loss additive)
5. Lime (alkalinity source)
6. Fresh Water and (25 wt %) CaCl2(s) (discontinuous phase)
7. API Barite (weighting agent)

Muds were tested initially for FANN 35 rheology and ESV and retested for theology, ESV and HTHP after ageing by hot rolling at 250° F. (121.1° C.) for 16 hours.

A number of OBM viscosifiers were screened in an optimised 45:55 HIPR formulation mud containing a minimal level of 1.0 ppb (pound per barrel) organoclay viscosifier. A bulk volume of base mud was prepared on the Silverson mixer over one hour at 6000 rpm and the viscosifier added and mixed for a further 20 minutes on the Hamilton Beech mixer. Muds were tested initially for FANN 35 rheology and ESV, and retested after ageing for 16 hours at 250° F. (121.1° C.) for rheology, ESV and HTHP fluid loss.

### Ethocel

Table 1 shows the performance, after ageing of various organosoluble celluloses (ETHOCEL obtained from Dow Chemical Company) added to a drilling fluid composition comprising an OWR of 45:55, an emulsifier and 3.0 ppb of the rheological additive.

They are compared, after ageing, to a benchmark which does not comprise any of the rheological additive. As can be seen from Table 1, ETHOCEL 4 and ETHOCEL 20 gave a significant increase in the low shear (6 rpm) parameter as well as plastic viscosity.

The ratio of 6 rpm/PV shows the balance of the fluid and a high ratio is better. The ratio for Ethocel 4 and Ethocel 20 is particularly good.

TABLE 1

| | Plastic | Yield Point | | |
|---|---|---|---|---|
| | Viscosity(PV) | (YP) | | 6 rpm/ |
| | cP | (lb/100 ft²) | 6 rpm reading | PV |
| Benchmark | 52 | 21 | 6 | 0.12 |
| Ethocel 4 | 71 | 47 | 42 | 0.59 |
| Ethocel 20 | 62 | 30 | 22 | 0.35 |
| Ethocel 300 | 57 | 22 | 12 | 0.21 |

Table 2 shows the equivalent data for chloro-sulphonated elastomer (CSE) products. The CSE products were elastomers having a range of sulphonation and neutralisation. These products were tested initially at 0.5 ppb concentration of the rheological additive. All the CSE versions gave increases in plastic viscosity, yield point and 6 rpm reading over the benchmark. Two versions gave the largest improvement in 6 rpm reading and 6 rpm/PV ratio.

TABLE 2

| | Plastic | Yield Point | | |
|---|---|---|---|---|
| | Viscosity(PV) | (YP) | | |
| | cP | (lb/100 ft²) | 6 rpm reading | 6 rpm/PV |
| Benchmark | 52 | 21 | 6 | 0.11 |
| CSE 1 | 66 | 33 | 19 | 0.29 |
| CSE 2 | 60 | 33 | 17 | 0.28 |
| CSE 3 | 69 | 39 | 13 | 0.19 |
| CSE 4 | 73 | 36 | 11 | 0.15 |
| CSE 5 | 74 | 33 | 11 | 0.15 |
| CSE 6 | 79 | 40 | 11 | 0.14 |

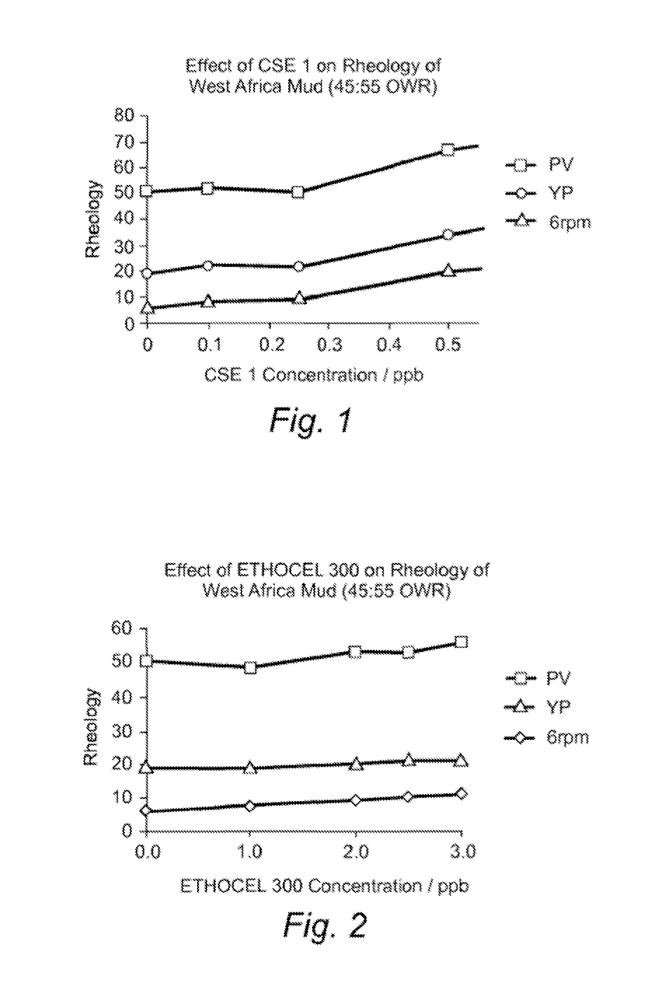

FIGS. 1 and 2 give concentration profiles showing the main rheology parameters for ETHOCEL 300 and CSE 1, respectively. The former (cellulosic) product gave a relatively linear profile throughout the 0-3.0 ppb range, whereas the sulphonated polymer gave a flat response up until 0.2 ppb after which the rheology was found to increase. A similar trend was observed for the CSE 6 polymer. For these cases, at least, the sulphonated polymer looks likely to be more sensitive to concentration than the cellulosic product and so appeared generally more effective based on the weight of additive.

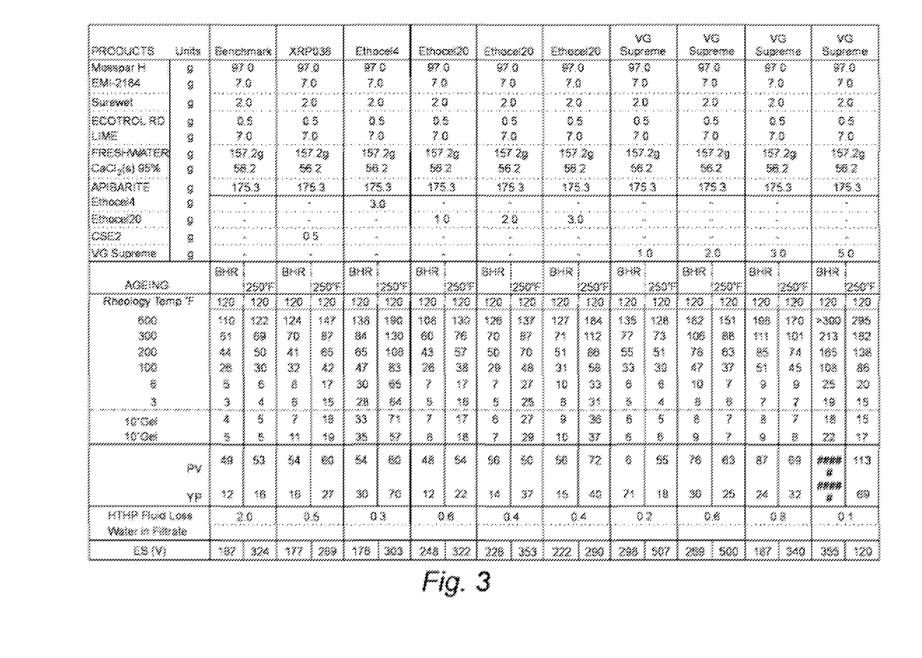

ETHOCEL 4, 20 and CSE 2, were retested in the same benchmark formulation as for the earlier experiments but with the organophilic clay rheology modifier component removed. Initial tests were at the concentration used in the initial tests i.e. 3.0 and 0.5 ppb, respectively, but additional tests were run at varying concentration in order to match the 6 rpm for each product at the same mud specification level. A comparison set of data for fluids at 1-5 ppb with the organophilic clay rheology modifier (VG Supreme) was included for comparison. The table shown in FIG. 3 shows the data.

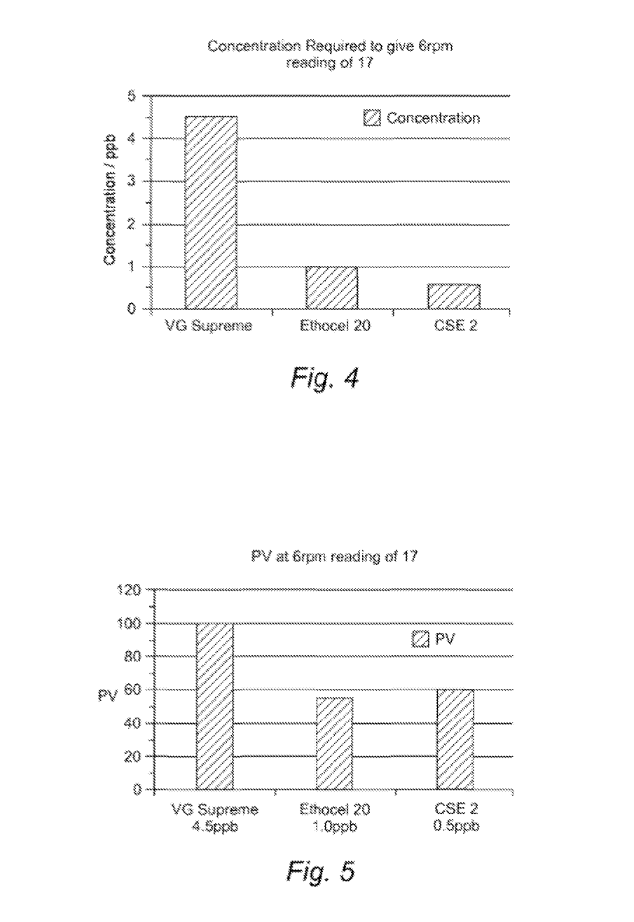

FIG. 4 shows the concentration of each additive required to achieve a 6 rpm reading of 17 and, in FIG. 5, its relative plastic viscosity. As can be seen, the amount of ETHOCEL 20 and CSE 2 required to achieve this low shear rate level is much less than the VG supreme. At these levels, their corresponding plastic viscosity is reduced. Thus for ETHOCEL 20 and CSE 2, these results show that a greatly improved 6 rpm/PV ratio was observed with a plastic viscosity of only half that for a organophilic clay (VG supreme). This makes these products particularly useful in formulations with less than 50:50 oil in water, that is High Internal Phase Rheology (HIPR).

Thus the results herein show emulsions with an improved rheology over US 2008/0248975 because they were found to give surprisingly low overall rheology in the HIPR system but allowed the low shear rate viscosity (LSRV) to be controlled to specification without excessive build up of plastic viscosity. Given the disclosure in US 2008/0248975, one would expect the low shear viscosity to be off-scale and not prove practicable.

### Example 2

Various 11.28 ppg invert emulsion fluids having a 70/30 O/W ratio were formulated as shown in Table 3 below. BIOBASE® 360 is a mixture of synthetic paraffins available from Shrieve Chemical Products Company (The Woodlands, Tex.). VG PLUS is an organophilic clay, SUREMUL® Plus is an amidoamine emulsifier, ECOTROL is a polymeric fluid loss control agent, RHEFLAT Plus is a mixed polyamine/polyamide rheology modifier, EMI-2718 is a sulphonated polymer according to the present disclosure, all of which are available from M-I SWACO (Houston, Tex.). OCMA clay, bentonitic clay having API/ISO specifications, was added to simulate drilling solids.

TABLE 3

| | Product: | | | | |
|---|---|---|---|---|---|
| | #1 | #2 | #3 | #4 | #5 |
| BioBase 360, g | 153.5 | 153.5 | 153.5 | 153.5 | 153.5 |
| VG Plus, g | 2 | 2 | 2 | 2 | 2 |
| Lime, g | 4 | 4 | 4 | 4 | 4 |
| SUREMUL ® Plus, g | 10 | 10 | 10 | 10 | 10 |
| Ecotrol F, g | 1 | 1 | 1 | 1 | 1 |
| 26% NaCl Brine, g | 114 | 114 | 114 | 114 | 114 |
| Barite, g | 177 | 177 | 177 | 177 | 177 |
| RHEFLAT PLUS, g | 1 | 1 | — | — | — |
| EMI-2718, g | — | 2 | 2 | 3 | 4 |
| OCMA, g | 25 | 25 | 25 | 25 | 25 |

The fluids were mixed at 1 bbl eq. using a single spindle and then sheared for 5 minutes on a Silverson mixer. The initial properties of the fluids were measured, and then the fluids were hot rolled at 250 F overnight. After hot rolling, the rheology and electrical stability of the fluids were measured. The rheological measurements were performed on a FANN 35 at various temperatures, the results of which are shown below in Tables 4A and 4B.

TABLE 4A

| | Fluid 1 | | | | | Fluid 2 | | | | | Fluid 3 | | | | |
|---|---|---|---|---|---|---|---|---|---|---|---|---|---|---|---|
| | 75 F. | 150 F. | 40 F. | 100 F. | 150 F. | 75 F. | 150 F. | 40 F. | 100 F. | 150 F. | 75 F. | 150 F. | 40 F. | 100 F. | 150 F. |
| 600 | 94 | 59 | 118 | 68 | 48 | 119 | 80 | 147 | 93 | 67 | 99 | 64 | 140 | 78 | 57 |
| 300 | 64 | 41 | 75 | 43 | 30 | 84 | 57 | 102 | 63 | 43 | 58 | 37 | 82 | 42 | 31 |
| 200 | 52 | 31 | 57 | 34 | 23 | 70 | 47 | 83 | 53 | 35 | 42 | 27 | 60 | 31 | 22 |
| 100 | 38 | 24 | 40 | 25 | 17 | 54 | 36 | 64 | 42 | 26 | 27 | 18 | 36 | 19 | 14 |
| 6 | 17 | 11 | 19 | 12 | 7 | 27 | 18 | 39 | 22 | 12 | 10 | 6 | 8 | 5 | 4 |
| 3 | 15 | 10 | 18 | 10 | 6 | 25 | 16 | 35 | 19 | 10 | 8 | 5 | 6 | 4 | 3 |
| PV | 30 | 18 | 43 | 25 | 18 | 35 | 23 | 45 | 30 | 24 | 41 | 27 | 58 | 36 | 26 |
| YP | 34 | 23 | 32 | 18 | 12 | 49 | 34 | 57 | 33 | 19 | 17 | 10 | 24 | 6 | 5 |
| 10″ | 14 | 10 | 17 | 10 | 7 | 25 | 18 | 39 | 21 | 13 | 11 | 7 | 9 | 5 | 5 |
| Gels | | | | | | | | | | | | | | | |
| 10′ Gels | 17 | 14 | 21 | 12 | 8 | 30 | 23 | 46 | 25 | 17 | 15 | 10 | 12 | 8 | 7 |
| ES | | 194 | | | 451 | | 335 | | | 408 | | 367 | | | 405 |

| | | | |
|---|---|---|---|
| HTHP | 54.6 | 23.3 | 16 |
| at | | | |
| 250 F. | | | |
| Water | 17 | 7 | 4.4 |
| Cake | 0.5 inch | 0.25 inch | 0.25 inch |
| size | | | |

TABLE 4B

| | Fluid 4 | | | | | Fluid 5 | | | | |
|---|---|---|---|---|---|---|---|---|---|---|
| | 75 F. | 150 F. | 40 F. | 100 F. | 150 F. | 75 F. | 150 F. | 40 F. | 100 F. | 150 F. |
| 600 | 111 | 72 | 140 | 86 | 67 | 128 | 91 | 160 | 116 | 92 |
| 300 | 69 | 45 | 84 | 54 | 41 | 83 | 58 | 101 | 75 | 59 |
| 200 | 52 | 35 | 63 | 42 | 32 | 65 | 45 | 78 | 60 | 46 |
| 100 | 34 | 23 | 40 | 28 | 21 | 45 | 31 | 52 | 41 | 32 |
| 6 | 14 | 9 | 14 | 10 | 8 | 23 | 14 | 22 | 18 | 13 |
| 3 | 12 | 8 | 13 | 9 | 7 | 21 | 12 | 20 | 15 | 12 |
| PV | 42 | 27 | 56 | 32 | 26 | 45 | 33 | 59 | 41 | 33 |
| YP | 27 | 18 | 28 | 22 | 15 | 38 | 25 | 42 | 34 | 26 |
| 10″ Gels | 16 | 10 | 16 | 12 | 9 | 26 | 16 | 26 | 20 | 15 |
| 10′ Gels | 23 | 15 | 23 | 18 | 13 | 35 | 22 | 36 | 27 | 21 |
| ES | | 380 | | | 445 | | 397 | | | 453 |

| | | |
|---|---|---|
| HTHP | 5.2 | 4.6 |
| at 250 F. | | |
| Water | 0.6 | 0.8 |
| Cake size | ′⅛ | ′⅛ |

### Example 2

An operator planned to drill an HTHP well with bottom hole temperature reaching 350 F. An invert emulsion fluid system containing a viscosifier referred to as RHETHIK™ HT (a polyacrylate-based viscosifier previously available from MI SWACO) was used to drill the previous HTHP well successfully in 2010. However, the production of RHETHIK™ HT was terminated by the supplier due to lack of raw material, and thus a new and alternative viscosifier that provides similar performance at HTHP conditions is required to ensure the success of the operation.

A 16 ppg invert emulsion formulation from 2010 (RHELIANT M, available from MI SWACO (Houston, Tex.) without RHETHIK™ HT was used as a starting point for the initial evaluation. Due to lack of performance, the fluid formulations were modified subsequently with a new viscosifier (EMI-2718) to improve rheology profile. Tables 5 and 6 below shows the various changes made during the evaluation. ESCAID® 110 hydrocarbon fluid is a petroleum distillate commercially available from EXXON-MOBIL Corp. VERSAGEL® HT is a hectorite clay, SUREMUL® is an amidoamine surfactant, SUREWET is a wetting agent, ECOTROL RD is a polymeric fluid loss control agent, RHEFLAT is a mix of poly fatty acids, RHEFLAT PLUS is a mixed polyamine/polyamide theology modifier, EMI-2718 is a sulphonated polymer according to the present disclosure, ONE-TROL HT is an amine-treated tannin, all of which are available from MI SWACO (Houston, Tex.).

TABLE 5
16 ppg RHELIANT M formulations tested for HTHP application
at 350 F. without using RHETHIK ™ HT

| | A | B | C | D | E | F | G | H |
|---|---|---|---|---|---|---|---|---|
| OWR | 75/25 | 75/25 | 75/25 | 75/25 | 75/25 | 75/25 | 75/25 | 80/20 |
| HR | 250 | 250 | 350 | 350 | 350 | 350 | 350 | 350 |
| Temperature, | | | | | | | | |
| F. | | | | | | | | |
| Escaid | 126 | 126 | 126 | 126 | 122.5 | 122 | 122.5 | 130 |
| 110, g | | | | | | | | |
| Versagel | 1.5 | 1.5 | 0.5 | 0.5 | 0.5 | 0.5 | 1 | 1.5 |
| HT, g | | | | | | | | |
| Lime, g | 8 | 8 | 8 | 8 | 8 | 8 | 8 | 8 |
| Suremul, g | 12 | 12 | 12 | 12 | 12 | 12 | 12 | 12 |
| Surewet, g | 2 | 2 | 2 | 2 | 2 | 2 | 2 | 2 |
| 25% CaCl2 | 69 | 69 | 69 | 69 | 67 | 67 | 67 | 53.5 |
| Brine, g | | | | | | | | |
| Ecotrol | 2 | 2 | 2 | 2 | 2 | 2 | 2 | 2 |
| RD, g | | | | | | | | |
| Barite, g | 430 | 432 | 427 | 428 | 425 | 425 | 425 | 430 |
| OCMA, g | 15 | 15 | 20 | 20 | 20 | 20 | 20 | 20 |
| Rheflat, g | 2 | 2 | 2 | 2 | 3 | 4 | 3 | 3 |
| EMI-2718, g | — | 1 | 0.5 | 0.75 | 0.5 | 0.5 | 0.5 | 0.5 |
| One-Trol | 5 | 5 | 10 | 10 | 10 | 10 | 10 | 10 |
| HT, g | | | | | | | | |

TABLE 6
16 ppg RHELIANT Plus formulations tested for HTHP
application of 350 F. without using RHETHIK ™ HT

| | 1 | 2 | 3 | 4 | 5 | 6 | 7 | 8 |
|---|---|---|---|---|---|---|---|---|
| OWR | 75/25 | 75/25 | 75/25 | 75/25 | 75/25 | 75/25 | 70/30 | 80/20 |
| HR | 250 | 250 | 350 | 350 | 350 | 350 | 350 | 350 |
| Temperature, | | | | | | | | |
| F. | | | | | | | | |
| Escaid | 128 | 128 | 128 | 128 | 126 | 126 | 116 | 132 |
| 110, g | | | | | | | | |
| Versagel | 1 | 0.5 | 0.75 | 0.5 | 0.5 | 0.5 | 0.5 | 1 |
| HT, g | | | | | | | | |
| Lime, g | 6 | 6 | 6 | 6 | 6 | 6 | 8 | 8 |
| One-Mul, g | 12 | 12 | 12 | 12 | 12 | 12 | 12 | 12 |
| Ecotrol | 2 | 2 | 2 | 2 | 2 | 2 | 2 | 2 |
| RD, g | | | | | | | | |
| 25% CaCl2 | 71 | 71 | 71 | 71 | 70 | 70 | 83 | 55 |
| Brine, g | | | | | | | | |
| Barite, g | 429 | 429 | 429 | 429 | 427 | 428 | 420 | 430 |
| RHEFLAT | 1 | 1 | 1.5 | 2 | 2 | 4 | 3 | 2 |
| PLUS, g | | | | | | | | |
| EMI-2718 g | — | — | — | — | 0.5 | 0.5 | 0.5 | 1 |
| One-Trol | 5 | 5 | 10 | 10 | 6 | 6 | 10 | 10 |
| HT, g | | | | | | | | |
| OCMA, g | 20 | 20 | 20 | 20 | 20 | 20 | 20 | 20 |

The test fluids were mixed using single spindle mixers, then they were sheared for 5 minutes at 6,000 rpm on Silverson mixer before hot rolling overnight at 350 F. The test fluids were tested at different temperatures for theology and ES before and after heat aging. The HTHP fluid loss was tested at 350 F after heat aging.

Table 7a to 7d below shows the fluid properties before and after heat aging at temperatures indicated. Fluid B in Table 7a shows the introduction of the new viscosifier, EMI-2718, helped to boost the rheology profile appreciably but the profile was not flat in the RHELIANT M system. As a result, the subsequent tests were focused on flattening the rheology profile by adjusting the concentration of Versagel HT, Rhelflat and the viscosifier. Table 7d shows relatively flat rheology profiles could be obtained using formulations G and H with good HTHP fluid loss control.

TABLE 7a
Fluid properties of 16 ppg RHELIANT M after heat aging at 250 F. without
RHETHIK ™ HT

| | A | | | | B | | | |
|---|---|---|---|---|---|---|---|---|
| | Initial | AHR at 250 F. | | | Initial | AHR at 250 F. | | |
| Rheology Temp | 120 F. | 40 F. | 100 F. | 150 F. | 120 F. | 40 F. | 100 F. | 150 F. |
| 600 | 91 | 182 | 97 | 71 | 120 | 212 | 140 | 93 |
| 300 | 50 | 100 | 56 | 41 | 72 | 125 | 85 | 57 |
| 200 | 37 | 72 | 42 | 31 | 56 | 94 | 65 | 44 |
| 100 | 23 | 43 | 27 | 21 | 38 | 57 | 43 | 30 |
| 6 | 6 | 11 | 8 | 8 | 15 | 16 | 17 | 14 |
| 3 | 6 | 10 | 8 | 8 | 14 | 15 | 16 | 13 |
| PV | 41 | 82 | 41 | 30 | 48 | 87 | 55 | 36 |
| YP | 9 | 18 | 15 | 11 | 24 | 38 | 30 | 21 |
| 10″ Gel | 8 | 14 | 10 | 10 | 20 | 20 | 23 | 20 |
| 10′ Gel | 16 | 29 | 22 | 20 | 40 | 47 | 44 | 36 |
| ES | 554 | | | 623 | 548 | | | 509 |
| HTHP 350 F. | | | | — | | | | — |

TABLE 7b
Fluid properties of 16 ppg RHELIANT M after heat aging at 350 F. with new
viscosifier

| | C | | | | D | | | |
|---|---|---|---|---|---|---|---|---|
| | Initial | AHR at 350 F. | | | Initial | AHR at 350 F. | | |
| Rheology Temp | 120 F. | 40 F. | 100 F. | 150 F. | 120 F. | 40 F. | 100 F. | 150 F. |
| 600 | 108 | 180 | 93 | 63 | 128 | 223 | 117 | 76 |
| 300 | 65 | 97 | 54 | 35 | 78 | 123 | 65 | 43 |
| 200 | 50 | 69 | 39 | 26 | 60 | 87 | 47 | 32 |
| 100 | 34 | 39 | 24 | 17 | 41 | 49 | 28 | 20 |
| 6 | 13 | 7 | 7 | 6 | 17 | 8 | 8 | 7 |
| 3 | 13 | 6 | 6 | 5 | 16 | 6 | 6 | 6 |
| PV | 43 | 83 | 39 | 28 | 50 | 100 | 52 | 33 |
| YP | 22 | 14 | 15 | 7 | 28 | 23 | 13 | 10 |
| 10″ Gel | 17 | 9 | 9 | 8 | 22 | 11 | 10 | 10 |
| 10′ Gel | 32 | 17 | 15 | 12 | 42 | 21 | 18 | 15 |
| ES | 611 | | | 676 | 553 | | | 604 |
| HTHP 350 F., mls | | | | 3.2 | | | | 4.8 |
| Water, mls | | | | 0 | | | | 0.2 |

TABLE 7c
Fluid properties of 16 ppg RHELIANT M after heat aging at 350 F. with new
viscosifier

| | E | | | | F. | | | |
|---|---|---|---|---|---|---|---|---|
| | Initial | AHR at 350 F. | | | Initial | AHR at 350 F. | | |
| Rheology Temp | 120 F. | 40 F. | 100 F. | 150 F. | 120 F. | 40 F. | 100 F. | 150 F. |
| 600 | 117 | 219 | 116 | 74 | 124 | 234 | 126 | 79 |
| 300 | 69 | 119 | 67 | 42 | 73 | 127 | 73 | 44 |
| 200 | 52 | 84 | 49 | 31 | 57 | 89 | 53 | 33 |
| 100 | 34 | 46 | 29 | 20 | 38 | 49 | 32 | 22 |
| 6 | 13 | 7 | 8 | 8 | 14 | 8 | 9 | 9 |
| 3 | 11 | 6 | 7 | 7 | 13 | 6 | 8 | 8 |
| PV | 48 | 100 | 49 | 32 | 51 | 107 | 53 | 35 |
| YP | 21 | 19 | 18 | 10 | 22 | 20 | 20 | 9 |
| 10″ Gel | 16 | 8 | 10 | 9 | 18 | 9 | 12 | 12 |
| 10′ Gel | 33 | 22 | 23 | 19 | 39 | 25 | 26 | 22 |
| ES | 858 | | | 826 | 918 | | | 820 |
| HTHP 350 F., mls | | | | 2.8 | | | | 2 |
| Water, mls | | | | 0 | | | | 0 |

TABLE 7d
Fluid properties of 16 ppg RHELIANT M after heat aging at 350 F. with new
viscosifier

| | G | | | | H | | | |
|---|---|---|---|---|---|---|---|---|
| | Initial | AHR at 350 F. | | | Initial | AHR at 350 F. | | |
| Rheology Temp | 120 F. | 40 F. | 100 F. | 150 F. | 120 F. | 40 F. | 100 F. | 150 F. |
| 600 | 136 | 227 | 125 | 85 | 120 | 206 | 110 | 76 |
| 300 | 81 | 125 | 74 | 51 | 72 | 113 | 65 | 46 |
| 200 | 63 | 91 | 56 | 39 | 56 | 81 | 49 | 36 |
| 100 | 43 | 52 | 36 | 27 | 38 | 47 | 32 | 25 |
| 6 | 17 | 11 | 12 | 12 | 15 | 11 | 12 | 13 |
| 3 | 16 | 9 | 11 | 12 | 15 | 9 | 11 | 13 |
| PV | 55 | 102 | 51 | 34 | 48 | 93 | 45 | 30 |
| YP | 26 | 23 | 23 | 17 | 24 | 20 | 20 | 16 |
| 10″ Gel | 22 | 12 | 14 | 16 | 10 | 10 | 14 | 19 |
| 10′ Gel | 52 | 34 | 38 | 31 | 34 | 34 | 41 | 33 |
| ES | 650 | | | 830 | 846 | | | 1065 |
| HTHP 350 F., mls | | | | 2 | | | | 2.2 |
| Water, mls | | | | 0 | | | | 0 |

Table 8a to 8d below shows the properties of RHELIANT Plus before and after heat aging. The initial focus was on formulations without using RHETHIK™ HT or the new viscosifier, EMI-2718. However, they were not successful, especially when HTHP fluid loss control was also required. The incorporation of the new viscosifier, EMI-2718, was eventually included and which resulted in some improvement.

TABLE 8a
Fluid properties of 16 ppg RHELIANT Plus after heat aging at 250 F. w/o
viscosifier

| | 1 | | | | 2 | | | |
|---|---|---|---|---|---|---|---|---|
| | Initial | AHR at 250 F. | | | Initial | AHR at 250 F. | | |
| Rheology Temp | 120 F. | 40 F. | 100 F. | 150 F. | 120 F. | 40 F. | 100 F. | 150 F. |
| 600 | 85 | 150 | 80 | 63 | 82 | 133 | 77 | 61 |
| 300 | 53 | 83 | 44 | 35 | 50 | 71 | 43 | 34 |
| 200 | 41 | 60 | 33 | 26 | 39 | 50 | 31 | 26 |
| 100 | 28 | 35 | 20 | 17 | 26 | 29 | 19 | 16 |
| 6 | 9 | 8 | 5 | 5 | 7 | 6 | 5 | 5 |
| 3 | 7 | 7 | 5 | 4 | 6 | 5 | 4 | 4 |
| PV | 32 | 67 | 36 | 28 | 32 | 62 | 34 | 27 |
| YP | 21 | 16 | 8 | 7 | 18 | 9 | 9 | 7 |
| 10″ Gel | 9 | 8 | 5 | 5 | 8 | 6 | 5 | 5 |
| 10′ Gel | 14 | 12 | 8 | 6 | 12 | 9 | 7 | 6 |
| | 700 | | | 564 | 631 | | | 589 |
| ES | 85 | 150 | 80 | 63 | 82 | 133 | 77 | 61 |
| HTHP 350 F. | | | | — | | | | — |

TABLE 8b
Fluid properties of 16 ppg RHELIANT Plus after heat aging at 350 F. w/o
viscosifier

| | 3 | | | | 4 | | | |
|---|---|---|---|---|---|---|---|---|
| | Initial | AHR at 350 F. | | | Initial | AHR at 350 F. | | |
| Rheology Temp | 120 F. | 40 F. | 100 F. | 150 F. | 120 F. | 40 F. | 100 F. | 150 F. |
| 600 | 121 | 154 | 75 | 54 | 114 | 150 | 81 | 58 |
| 300 | 78 | 83 | 40 | 28 | 66 | 80 | 43 | 30 |
| 200 | 62 | 58 | 29 | 20 | 49 | 56 | 30 | 21 |
| 100 | 44 | 33 | 17 | 13 | 30 | 31 | 18 | 13 |
| 6 | 20 | 6 | 4 | 4 | 8 | 5 | 4 | 4 |
| 3 | 18 | 5 | 3 | 3 | 7 | 4 | 3 | 3 |
| PV | 43 | 71 | 35 | 26 | 48 | 70 | 38 | 28 |
| YP | 35 | 12 | 5 | 2 | 18 | 10 | 5 | 2 |
| 10″ Gel | 22 | 6 | 5 | 4 | 9 | 7 | 5 | 5 |
| 10′ Gel | 31 | 9 | 6 | 5 | 16 | 9 | 7 | 6 |
| | 675 | | | 532 | 843 | | | 541 |
| ES | | | | | | | | |
| HTHP 350 F., mls | | | | 8.8 | | | | 6.4 |
| Water, mls | | | | 0.1 | | | | Trc |

TABLE 8c
Fluid properties of 16 ppg RHELIANT Plus after heat aging at 350 F. with
viscosifier

| | 5 | | | | 6 | | | |
|---|---|---|---|---|---|---|---|---|
| | Initial | AHR at 350 F. | | | Initial | AHR at 350 F. | | |
| Rheology Temp | 120 F. | 40 F. | 100 F. | 150 F. | 120 F. | 40 F. | 100 F. | 150 F. |
| 600 | 117 | 151 | 87 | 60 | 121 | 182 | 99 | 69 |
| 300 | 76 | 83 | 48 | 32 | 78 | 98 | 55 | 37 |
| 200 | 63 | 59 | 36 | 25 | 62 | 69 | 40 | 29 |
| 100 | 47 | 34 | 22 | 17 | 44 | 38 | 25 | 19 |
| 6 | 25 | 6 | 7 | 6 | 21 | 5 | 7 | 7 |
| 3 | 23 | 5 | 6 | 5 | 20 | 4 | 6 | 6 |
| PV | 41 | 68 | 39 | 28 | 43 | 84 | 44 | 32 |
| YP | 35 | 15 | 9 | 4 | 35 | 14 | 11 | 5 |
| 10″ Gel | 25 | 7 | 7 | 6 | 23 | 5 | 10 | 10 |
| 10′ Gel | 34 | 14 | 12 | 9 | 35 | 15 | 19 | 18 |
| | 589 | | | 573 | 289 | | | 631 |
| ES | | | | | | | | |
| HTHP 350 F., mls | | | | 9.6 | | | | 8.8 |
| Water, mls | | | | — | | | | — |

TABLE 8d
Fluid properties of 16 ppg RHELIANT Plus after heat aging at 350 F. with
viscosifier

| | 7 | | | | 8 | | | |
|---|---|---|---|---|---|---|---|---|
| | Initial | AHR at 350 F. | | | Initial | AHR at 350 F. | | |
| Rheology Temp | 120 F. | 40 F. | 100 F. | 150 F. | 120 F. | 40 F. | 100 F. | 150 F. |
| 600 | 196 | 287 | 147 | 101 | 166 | 207 | 106 | 73 |
| 300 | 117 | 163 | 87 | 60 | 98 | 116 | 61 | 42 |
| 200 | 90 | 117 | 64 | 45 | 76 | 83 | 45 | 31 |
| 100 | 58 | 67 | 41 | 29 | 51 | 48 | 29 | 20 |
| 6 | 22 | 12 | 12 | 10 | 21 | 9 | 9 | 8 |
| 3 | 20 | 10 | 10 | 8 | 19 | 8 | 8 | 7 |
| PV | 79 | 124 | 60 | 41 | 68 | 91 | 45 | 31 |
| YP | 38 | 39 | 27 | 19 | 30 | 25 | 16 | 11 |
| 10″ Gel | 26 | 12 | 12 | 11 | 26 | 10 | 9 | 8 |
| 10′ Gel | 42 | 22 | 19 | 16 | 41 | 21 | 16 | 13 |
| | 560 | | | 616 | 749 | | | 753 |
| ES | | | | | | | | |
| HTHP 350 F., mls | | | | 4 | | | | 4 |
| Water, mls | | | | — | | | | — |

### Example 3

The reservoir section of the re-entry well WA-7 ST2 was drilled with RHELIANT drilling fluid. Rheology of the fluid was kept on the lower side before cementing 7⅝″ liner to minimize ECD & surge pressures and to achieve optimum cementing for zonal isolation.

Total losses were encountered while drilling at 5,486 m. While attempting to cure the losses the annulus was filled via trip tank with fresh 7.7 ppg mud. This mud was freshly mixed and wasn't sheared well. During the losses the string got stuck, after getting free and while pulling out to shoe it was observed that well is kicking. The well was shut-in with light 7.7 ppg mud in the annulus. At this point well was circulated by freshly mixed 15.15 ppg fluid. This mud was also not sheared well due to the slow pump rate during well control operations. Before running in hole with the 7⅝″ liner mud weight was increased to 15.45 ppg and mud theology was reduced to YP −16 & YZ −8. A 350 bbl low rheology spacer was pumped ahead of cement spacer to lower cementing ECD. The system then treated with polymers to maintain the rheology in specs without enough time to get the mud sheared and achieve actual rheologies. After cementing the liner, the rheologies were still maintained at the low side of specifications to minimize the pressure at the top of liner while running with tie back. After the tie back, when the first sag incident was observed; the un-sheared mud was static for around 2 weeks in a high angle well of 50° Inclination with high bottom hole temperature of 250°-260° F.

At the end of tie back operation, and before any sag incident, the excess surface volume was back loaded and a sample from this mud was sent to M-I SWACO Dubai Lab. This mud represents the actual mud left in the hole before the first sag incident. The sample received at Dubai lab was having good theology but high dynamic sag; it was optimized to reduce sag by the treatment with organophilic clay and emulsifier together with ample shearing. The field sample was also evaluated for high temperature stability with two products RHETHIK™ HT and EMI-2718. Sample treated with EMI-2718 showed better rheological properties after hot rolling at 350° F. as compare to RHETHIK™ HT, which showed signs of high temperature gelation.

Complete mud check was done on the field mud received at Dubai lab as shown in the Table 9 below. Mud properties and rheology of the sample were in a good range.

TABLE 9
Field Mud Properties

| Mud Weight, PPG | 14.93 | | |
|---|---|---|---|
| Rheology Temp, ° F. | 73 | 120 | 150 |
| 600 rpm | 75 | 63 | 52 |
| 300 rpm | 42 | 36 | 31 |
| 200 rpm | 30 | 27 | 23 |
| 100 rpm | 17 | 17 | 16 |
| 6 rpm | 5 | 6 | 8 |
| 3 rpm | 3 | 6 | 7 |
| PV, cps | 33 | 27 | 21 |
| YP, lbs/100 ft² | 9 | 9 | 10 |
| 10 Sec Gel | 6 | 12 | 14 |
| 10 Min Gel | 24 | 23 | 28 |

| HTHP @ 350° F. | 13.6 | cc |
|---|---|---|
| E.S., Vts @ 120° F. | 754 | |
| POM | 3.6 | |
| Excess Lime, ppb | 4.7 | |
| Solids, % by Vol | 29.2 | |
| Oil, % by Vol | 54.4 | |
| Water, % by Vol | 16.4 | |
| Syn/Water Ratio | 77/23 | |
| Cl, whole mud, mg/L | 22000 | |
| VSST, PPG | 4.18 | |
| Static Sag @ 250° F. and 200 psi | 24 | hrs |

| Free Oil, ml | 24 | |
|---|---|---|
| Top weight, SG | 1.803 | |
| Middle weight, SG | 1.852 | |
| Bottom weight, SG | 1.926 | |
| Sag Factor | 0.517 | |
| Static Sag @ 350° F. and 300 psi | 24 hrs | 72 hrs |
| Free Oil, ml | 20 | 30 |
| Top weight, SG | 1.723 | 1.763 |
| Middle weight, SG | 1.759 | 1.868 |
| Bottom weight, SG | 1.832 | 1.916 |
| Sag Factor | 0.515 | 0.521 |

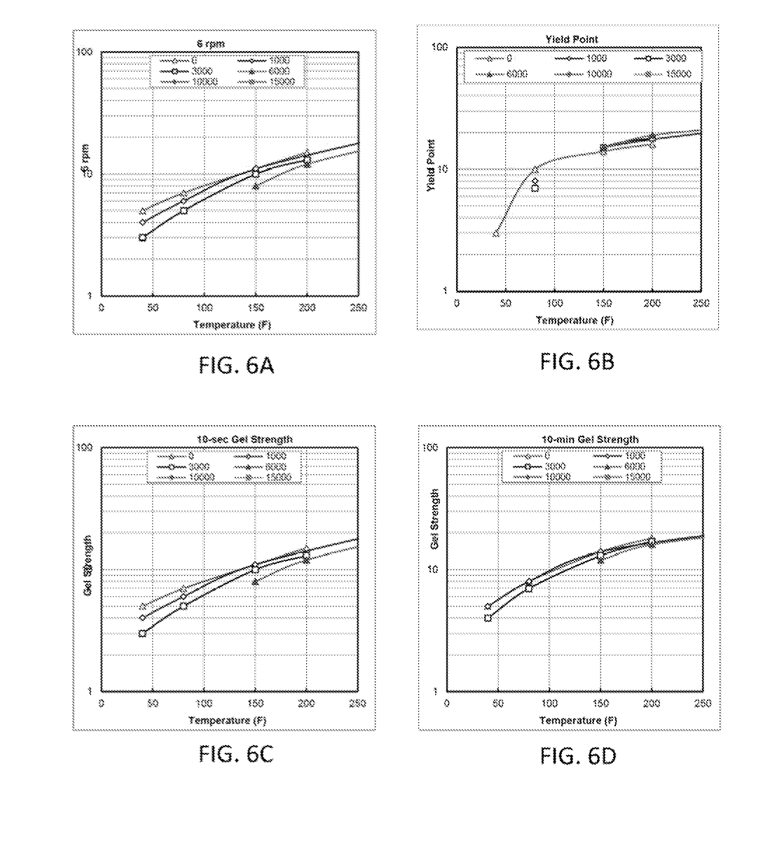

FANN 70 analysis of this field sample was performed and it showed that the rheology of the sample was increasing with the rising temperature, (FIGS. 6A-D). This indicates that the mud was having excess amount of temperature activated polymers and it needs clay base to improve its rheological profile. Shortage of clay can also lead to high sag potential.

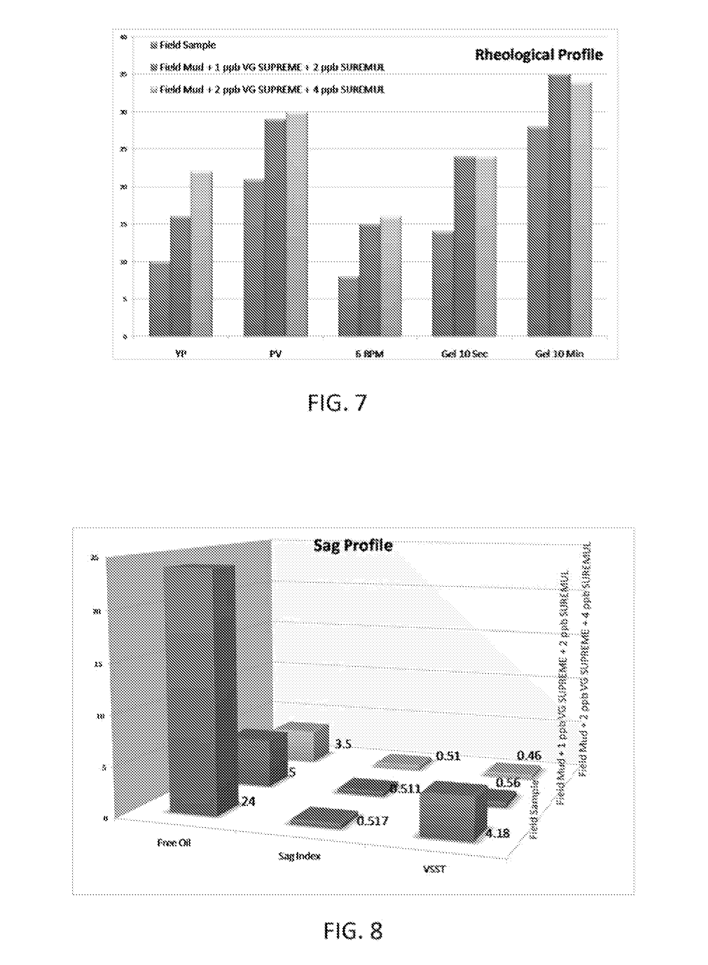

For optimization of properties one mud sample was treated with 1 ppb VG SUPREME (Organophilic clay) and 2 ppb SUREMUL (Emulsifier) and another was treated with 2 ppb VG SUPREME and 4 ppb SUREMUL. Significant improvements were observed in dynamic sag reading (Viscometer Sag Shoe test, VSST) and in the amount of free oil in static settling test after the treatment of 1 ppb VG SUPREME and 2 ppb SUREMUL, indicating that ample shearing and a small treatment of clay and emulsifier is enough to effectively mitigate the sag. In the second sample, sag numbers were slightly better but the improvement was not significant as compare to the amount of treatment. (Table 10, FIGS. 7 and 8)

TABLE 10

| | | | | Field Mud + 1 ppb | | | Field Mud + 2 | | |
|---|---|---|---|---|---|---|---|---|---|
| | | | | VG SUPREME + 2 | | | ppb VG SUPREME + | | |
| Mud Properties | Field Sample | | | ppb SUREMUL | | | 4 ppb SUREMUL | | |
| Mud Weight, PPG | 14.93 | | | 14.93 | | | 14.93 | | |
| Rheology Temp, | 73 | 120 | 150 | 73 | 120 | 150 | 73 | 120 | 150 |
| ° F. | | | | | | | | | |
| 600 rpm | 75 | 63 | 52 | 125 | 83 | 74 | 146 | 93 | 82 |
| 300 rpm | 42 | 36 | 31 | 71 | 50 | 45 | 84 | 57 | 52 |
| 200 rpm | 30 | 27 | 23 | 52 | 39 | 36 | 62 | 46 | 43 |
| 100 rpm | 17 | 17 | 16 | 31 | 25 | 25 | 37 | 32 | 30 |
| 6 rpm | 5 | 6 | 8 | 10 | 12 | 15 | 13 | 15 | 16 |
| 3 rpm | 3 | 6 | 7 | 9 | 11 | 13 | 11 | 13 | 14 |
| PV, cps | 33 | 27 | 21 | 54 | 33 | 29 | 62 | 36 | 30 |
| YP, lbs/100 ft² | 9 | 9 | 10 | 17 | 17 | 16 | 22 | 21 | 22 |
| 10 Sec Gel | 6 | 12 | 14 | 14 | 20 | 24 | 15 | 25 | 24 |
| 10 Min Gel | 24 | 23 | 28 | 44 | 30 | 35 | 47 | 34 | 34 |

| E.S., Vts @ 120° F. | 754 | 536 | 601 |
|---|---|---|---|
| VSST, PPG | 4.18 | 0.56 | 0.46 |
| | 24 Hrs Static Sag @ 250° F. and 200 psi | | |
| Free Oil, ml | 24 | 5 | 3.5 |
| Top weight, SG | 1.803 | 1.739 | 1.746 |
| Middle weight, SG | 1.852 | 1.789 | 1.784 |
| Bottom weight, SG | 1.926 | 1.819 | 1.815 |
| Sag Factor | 0.517 | 0.511 | 0.510 |

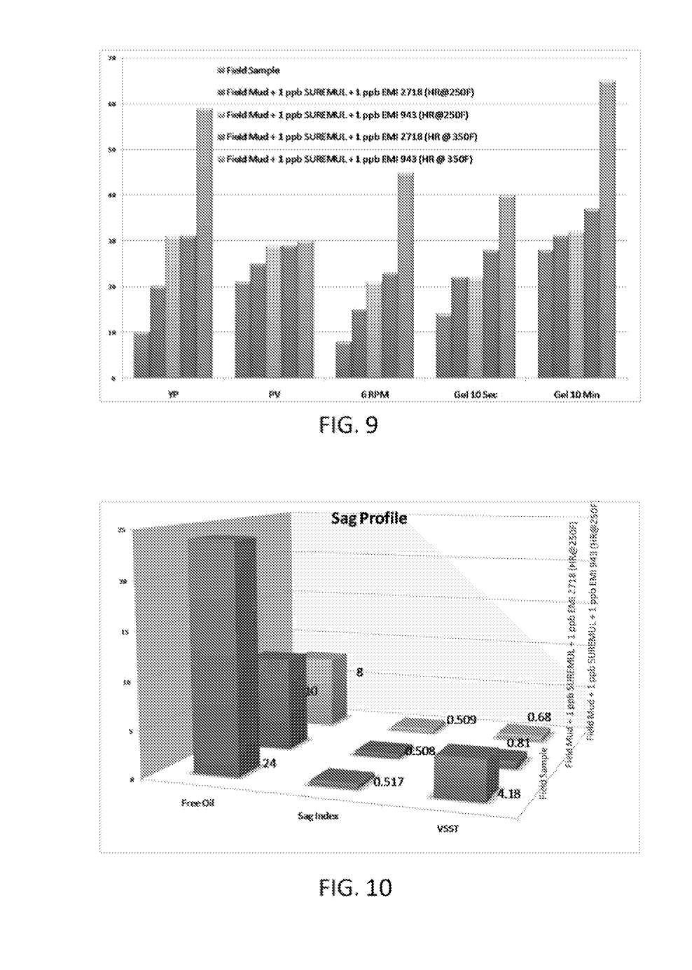

The field sample was also treated with high temperature rheology modifier, RHETHIK™ HT and EMI-2718, to evaluate their effect on the theology and sag potential. Both products helped in reducing sag at 250° F. This sample was also hot rolled at 350° F. to evaluate the high temperature stability of this treatment. At 350° F. some high temperature gelation was seen with the treatment of RHETHIK™ HT and sample treated with EMI-2718 kept its rheologies. (Table 11 and FIGS. 9 and 10)

TABLE 11

| | | | | Field Mud + 1 | | | Field Mud + 1 | | | Field Mud + 1 ppb | | | Field Mud + 1 ppb | | |
|---|---|---|---|---|---|---|---|---|---|---|---|---|---|---|---|
| Mud | | | | ppb SUREMUL + | | | ppb SUREMUL + | | | SUREMUL + 1 ppb | | | SUREMUL + 1 ppb | | |
| Properties | Field Sample | | | 1 ppb EMI 2718 | | | 1 ppb EMI 943 | | | EMI 2718 | | | EMI 943 | | |
| Hot Roll | | | | 250 | | | 250 | | | 350 | | | 350 | | |
| Temp, ° F. | | | | | | | | | | | | | | | |
| Mud Wt, | 14.93 | | | 14.93 | | | 14.93 | | | 14.93 | | | 14.93 | | |
| PPG | | | | | | | | | | | | | | | |
| Rheology | 73 | 120 | 150 | 73 | 120 | 150 | 73 | 120 | 150 | 73 | 120 | 150 | 73 | 120 | 150 |
| Tem, ° F. | | | | | | | | | | | | | | | |
| 600 rpm | 75 | 63 | 52 | 130 | 80 | 70 | 123 | 94 | 89 | 161 | 110 | 89 | 171 | 132 | 119 |
| 300 rpm | 42 | 36 | 31 | 80 | 50 | 45 | 79 | 62 | 60 | 99 | 71 | 60 | 111 | 96 | 89 |
| 200 rpm | 30 | 27 | 23 | 61 | 39 | 36 | 62 | 51 | 51 | 76 | 59 | 49 | 90 | 85 | 80 |
| 100 rpm | 17 | 17 | 16 | 40 | 27 | 26 | 43 | 36 | 40 | 51 | 41 | 37 | 63 | 65 | 65 |
| 6 rpm | 5 | 6 | 8 | 15 | 15 | 15 | 19 | 19 | 21 | 22 | 22 | 23 | 31 | 45 | 45 |
| 3 rpm | 3 | 6 | 7 | 13 | 13 | 13 | 16 | 16 | 19 | 20 | 20 | 21 | 29 | 41 | 41 |
| PV, cps | 33 | 27 | 21 | 50 | 30 | 25 | 44 | 32 | 29 | 62 | 39 | 29 | 60 | 36 | 30 |
| YP, | 9 | 9 | 10 | 30 | 20 | 20 | 35 | 30 | 31 | 37 | 32 | 31 | 51 | 60 | 59 |
| lbs/100 ft² | | | | | | | | | | | | | | | |
| 10 Sec Gel | 6 | 12 | 14 | 26 | 21 | 22 | 20 | 22 | 22 | 28 | 26 | 28 | 36 | 40 | 40 |
| 10 Min Gel | 24 | 23 | 28 | 43 | 33 | 31 | 41 | 33 | 32 | 46 | 35 | 37 | 57 | 60 | 65 |

| E.S., Vts @ | 754 | 669 | 622 |
|---|---|---|---|
| 120° F. | | | |
| VSST, PPG | 4.18 | 0.81 | 0.68 |
| | 24 Hrs Static Sag @ 250° F. and 200 psi | | |
| Free Oil, ml | 24 | 10 | 8 |
| Top wt, SG | 1.803 | 1.803 | 1.806 |
| Middle wt, | 1.852 | 1.810 | 1.815 |
| SG | | | |
| Bottom | 1.926 | 1.860 | 1.874 |
| wt, SG | | | |
| Sag Factor | 0.517 | 0.508 | 0.509 |

Improvements and modifications may be made without departing from the scope of the disclosure.

Although only a few example embodiments have been described in detail above, those skilled in the art will readily appreciate that many modifications are possible in the example embodiments without materially departing from embodiments disclosed herein. Accordingly, all such modifications are intended to be included within the scope of this disclosure. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A wellbore fluid that comprising:
an oleaginous external phase;
a non-oleaginous internal phase;
an emulsifier; and
a rheological additive comprising a sulphonated polymer formed from 100 to 10,000 monomers.

2. The fluid of claim 1, wherein the sulphonated polymer is a chlorosulphonated polymer.

3. The fluid of claim 1, wherein the sulphonated polymer is an α-olefin copolymer.

4. The fluid of claim 1, wherein the sulphonated polymer is comprised of repeat units which are derived from ethylene and an α-olefin that contains from 3 to 20 carbon atoms.

5. The fluid of claim 1, wherein the sulphonated polymer is a chlorosulphonated α-olefin copolymer which is comprised of repeat units which are derived from ethylene and an α-olefin that contains from 3 to 20 carbon atoms.

6. The fluid of claim 1, wherein the non-oleaginous internal phase comprises a plurality of droplets, said droplets having an average diameter in the range of from 0.5 to 5 micrometers.

7. The fluid of claim 6, wherein the average diameter of the droplets is in the range of from 1 to 3 micrometers.

8. The fluid of claim 1, wherein the ratio of the oleaginous external phase to the non-oleaginous internal phase is greater than 50:50.

9. The fluid of claim 8, wherein the ratio of the oleaginous external phase to the non-oleaginous internal phase ranges from 50:50 to 95:5.

10. The fluid of claim 1, wherein the non-oleaginous internal phase comprises brine with a specific gravity greater than 1.4.

11. The fluid of claim 1, wherein the emulsifier is an alkoxylated ether acid.

12. The fluid of claim 1, wherein the emulsifier is an alkoxylated ether acid represented by the following formula:
R⁴O[CH₂CHR¹O]ₙ[CH₂]ₘ—COOH
wherein R⁴ is a C₆-C₂₄ alkyl or alkenyl radical or —C(O)R³ (where R³ is a C₁₀-C₂₂ alkyl or alkenyl radical);
R¹ is H or a C₁-C₄ alkyl radical;
n has a value of from 1 to 20; and
m has a value of from 0 to 4.

13. The fluid of claim 11, wherein when R¹ is H, n has a value of from 1 to 10.

14. The fluid of claim 11, wherein n has a value of from 2 to 5.

15. The fluid of claim 11, wherein when R¹ is —CH₃, n has a value of from 1 to 20.

16. A method comprising:
drilling the subterranean hole using a invert emulsion wellbore fluid comprising:
an oleaginous external phase;
a non-oleaginous internal phase;
an emulsifier; and
a rheological additive comprising a sulphonated polymer formed from 100 to 10,000 monomers.

17. The method of claim 16, wherein the ratio of the oleaginous external phase to the non-oleaginous internal phase is greater than 50:50.

18. The method of claim 16, wherein the method further includes the step of mixing an oleaginous fluid, a non-oleaginous fluid, an emulsifier and a rheological additive to form the invert emulsion wellbore fluid.
